(19) United States
(12) Patent Application Publication
(10) Pub. No.: US 2007/0049193 A1
(43) Pub. Date: Mar. 1, 2007

(54) Satellite receiver for building selection list based on time

(75) Inventor: Robert J. Burnham, Novi, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 11/217,900

(22) Filed: Sep. 1, 2005

(51) Int. Cl. H04H 1/00

(52) U.S. Cl. 455/3.02; 455/12.1

(57) ABSTRACT

The present invention provides an improved receiver system including a tuner and a database. The tuner is configured to receive a signal including program signal data and program information data. The database is in communication with the tuner, allowing the tuner to store the program information data into the database and correlate the program information data with time markers indicative of user interest in the program signal data. The tuner is configured to generate a selection list based on the time markers and the program information data.

### BACKGROUND

1. Field of the Invention

The present invention generally relates to a satellite receiver system.

2. Description of Related Art

Many entertainment systems, such as radios, have allowed the user to select their favorite program channels as presets. This allows the user to quickly access radio stations playing the user's favorite genre of music. Previously, the user would need to switch between his favorite radio stations to find a particular title or manually insert a tape or CD to manually facilitate finding the song that the user desired to hear. More recently, MP3 and satellite radios have been providing additional program information data, such as genre, title, artist, album, along with the program signal data, such as the actual audio signal of a song. Since more information has become available along with the audio signal data, entertainment systems can more easily search and identify songs by title. Therefore, systems such as MP3 players have developed favorites lists that are organized by title.

However, the user's mood may change during the day. Stations or songs that the user wanted to hear during the morning may be different than those the user desires to listen to in the afternoon or evening. Currently, the user is still required to manually select song titles from the overall favorites lists, or in the case of an MP3 player the user may manually set up multiple favorites lists.

In view of the above, it is apparent that there exists a need for an improved satellite receiver system.

### SUMMARY

In satisfying the above need, as well as overcoming the enumerated drawbacks and other limitations of the related art, the present invention provides an improved receiver system including a tuner and a database. The tuner is configured to receive a signal including program signal data and program information data. The database is in communication with the tuner, allowing the tuner to store the program information data into the database and correlate the program information data with time markers indicative of user interest in the program signal data. The tuner is configured to generate a selection list based on the time markers and the program information data.

The tuner is configured to associate time markers with the program information data based on a song selection event, a new song event, or a channel change event. The tuner may associate the time marker with the genre, title, artist, or album of the program information data. In addition, the tuner can associate a time marker with program data based on a title selection from an auxiliary device, such as an MP3 player. The tuner may also be configured to display the title of a new song as it becomes available on a different channel based on the time markers associated with the title of the new song. For example, if the time markers indicate the user is more interested in the new song than the song currently playing, a single click interface may be provided to switch from the current song to the new song for a predetermined amount of time.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a diagrammatic view of a satellite receiver system in accordance with the present invention;

FIG. 2 is a flow chart illustrating the system logic when a new song is played on the same channel;

FIG. 3 is a flow chart illustrating the system logic when the user changes the channel;

FIG. 4 is a flow chart illustrating the system logic when a title from an auxiliary device is selected;

FIG. 5 is a flow chart of the system logic when a new song begins to play on a channel other than the current channel;

FIG. 6 is a flow chart illustrating the system logic when the user selects a genre favorites list;

FIG. 7 is a flow chart of the system logic when the user selects an artist favorites list; and

FIG. 8 is a flow chart of the system logic when the user selects an album favorites list.

### DETAILED DESCRIPTION

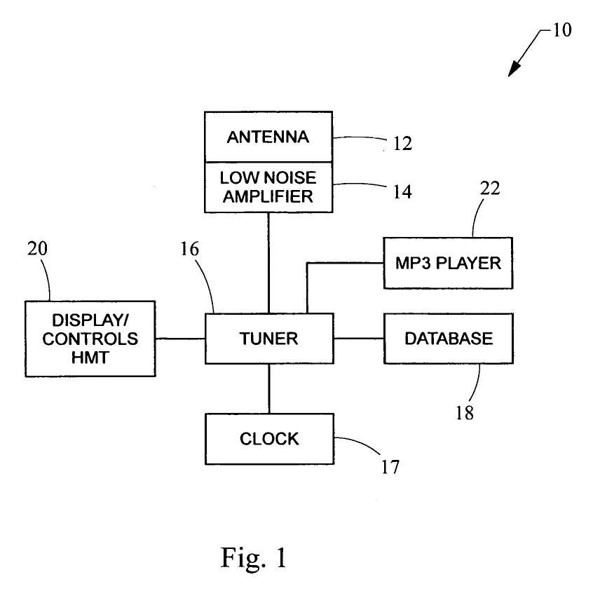

Referring now to FIG. 1, a satellite receiver system embodying the principles of the present invention is illustrated therein and designated at 10. As its primary components, the satellite receiver system 10 includes an antenna 12, a low noise amplifier 14, a tuner 16, and a database 18. The antenna 12 is generally a circularly polarized antenna, such as a patch, quadra filar helix, or cross dipole antenna. The antenna 12 receives the satellite signal and communicates the satellite signal to the low noise amplifier 14. The low noise amplifier 14 generates an amplified signal based on the satellite signal.

The tuner 16 receives the amplified signal and parses out the program information data about the current song. Further, some satellite providers also include program information data about the songs playing on every channel that is currently available to the satellite receiver. The tuner 16 is in electrical communication with a database 18 and a clock 17. The tuner 16 is configured to store the program information data such as genre, artist, album, and title into the database 18 for the current program (song) and the programs on any other available channels. In addition, the tuner 16 stores the time of day, from the clock 17, that a particular title is played by the user. The tuner may then query the database 18 to determine how often and what time of day certain titles, genre, or artists are played by the user. Therefore, the tuner 16 is able to dynamically build a selection list based on the user's listening habits.

Tuner 16 is in electrical communication with a human machine interface (HMI) 20 including tuner controls and a display. The selection list, provided on the HMI 20, is configured to provide easy access to titles that the user typically listens to during the current time of the day. Accordingly, the user may define particular time slots to segment the time of day and the database information can be queried based on the time slots. Further, the tuner 16 may be connected to an auxiliary device, for example an MP3 player 22. When the user plays a song using the MP3 player 22, the tuner 16 is configured to store the program information data into the database 18 and also make the song title available on the selection list.

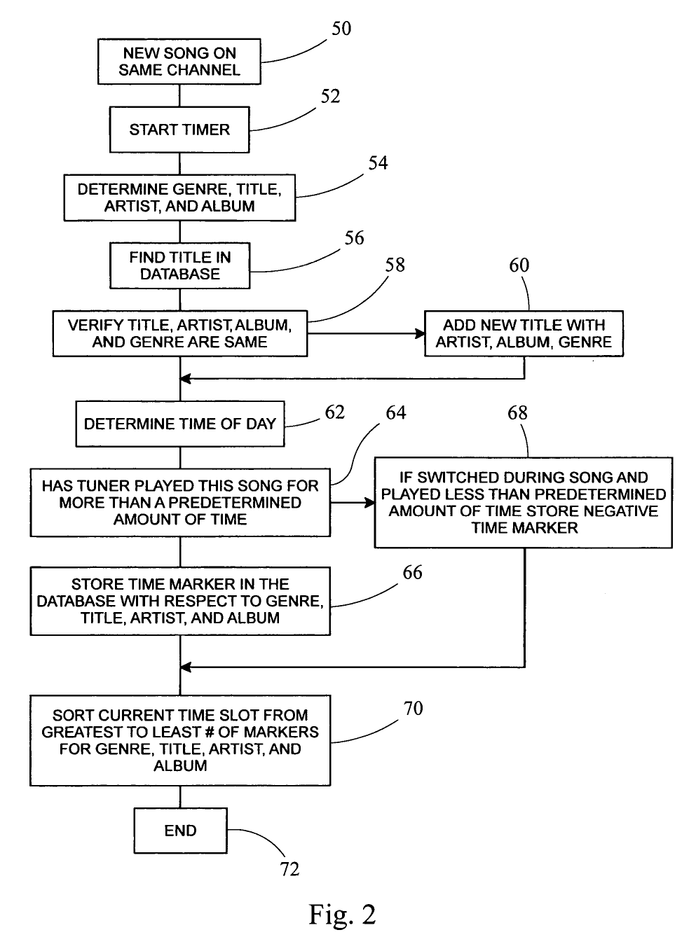

Now referring to FIG. 2, a flow chart is provided illustrating the system logic that is executed when a new song begins on the current channel, herein referred to as a new song event. The logic starts in block 50 where the tuner 16 determines a new song is beginning on the current channel. In block 52, a timer is started when the new song begins. In block 54, the tuner 16 determines the genre, title, artist, and album from the program information data. The tuner 16 then finds the title of the song in the database 18, as denoted by block 56. In block 58, the tuner verifies the artist, album and genre are the same for the given title.

If the artist, album and genre are not the same, the logic flows to block 60 and a new title is added with the new artist, album and/or genre information. If the artist, album, and genre are the same as the database entry, the logic flows directly to block 62 and the time of day is determined. In block 64, the tuner 16 determines if the song has played for more than a predetermined amount of time. If the tuner has played this song for more than a predetermined amount of time, the logic flows to block 66 and a time marker is stored in the database 18 with respect to the genre, title, artist, and album.

The time marker may include the actual time of day or alternatively, the time marker may simply be a counter associated with the genre, title, artist, and album that is incremented for a particular time slot. The time slots may be set by default at 3 hour increments, for example 6:00 AM to 9:00 AM, 9:00 AM to 12:00 noon, 12:00 noon to 3:00 PM, and 3:00 PM to 6:00 PM. Alternatively, the user interface may allow the user to define the time slots and optionally define time slots that are unequal in length or that vary based on the day of the week, month, or calendar year. By storing the actual time of day in the time marker, the tuner 16 is able to recalculate the ranking of the song, if the time slots are changed by the user.

If the tuner 16 has not played a song for more than a predetermined amount of time, block 68 determines if the user selects a different channel or song title before the song has finished and if the song has played less than a second predetermined amount of time. If the user selects a different channel or song title before the song is over and the song has played less than a predetermined amount of time, then the tuner 16 stores a negative time marker in the database 18. The negative time marker may simply be a decrement in a counter for a particular time slot, or alternatively may also include the actual time of day with a tag indicating the user changed the song at the particular time. As denoted in block 70, the tuner 16 then sorts the selection list based on the number of time markers for a genre, title, artist, or album for the current time slot. Accordingly, the tuner 16 anticipates the user's desired song choices and develops a selection list based on prior user listening habits. The system logic for a new song on the same channel is then complete as denoted by block 72.

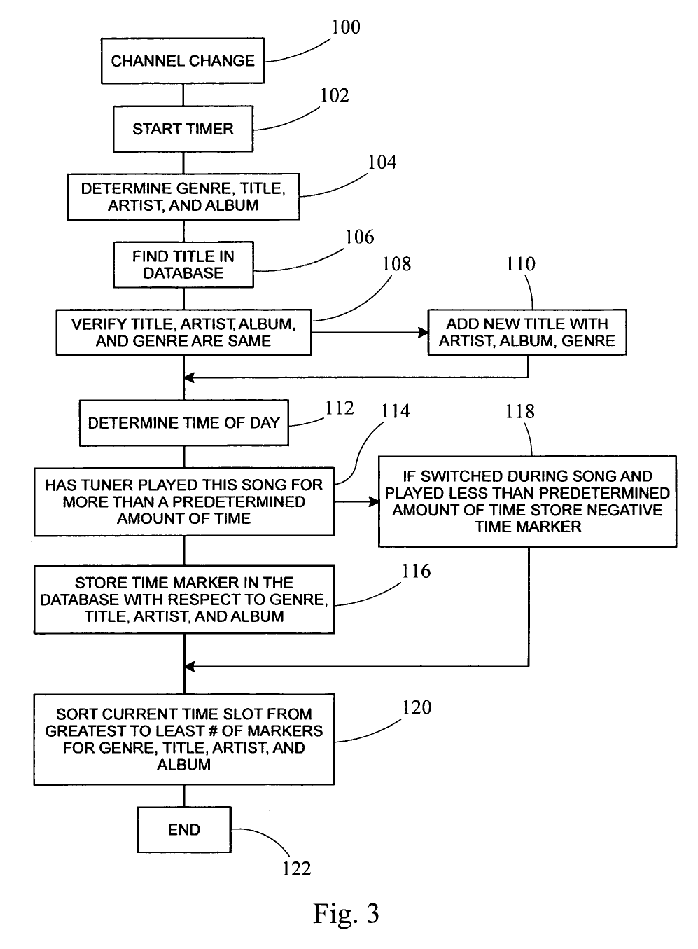

Now referring to FIG. 3, a flow chart is provided illustrating the system logic that is executed when the channel is changed by the user, herein referred to as a channel change event. The logic starts in block 100 where the tuner 16 receives a signal indicating the channel is being changed by the user. In block 102, a timer is started when a new song begins. In block 104, the tuner 16 determines the genre, title, artist, and album from the program information data. The tuner 16 then finds the title of the song in the database 18, as denoted by block 106. In block 108, the tuner 16 verifies the artist, album and genre are the same for the given title.

If the artist, album and genre are not the same, the logic flows to block 110 and a new title is added to the database 18 with the new artist, album and/or genre information. When the database 18 is full, the record with the lowest marker value is removed from the database 18 to make space for new titles. If the artist, album, and genre are the same as the database entry, the logic flows directly to block 112 and the time of day is determined. In block 114, the tuner 16 determines if the song has played for more than a predetermined amount of time. If the tuner 16 has played this song for more than a predetermined amount of time, the logic flows to block 116 and a time marker is stored in the database 18 with respect to the genre, title, artist, and album. As described above, the time marker may include the actual time of day or alternatively, the time marker may simply be a counter that is incremented for a particular time slot.

If the tuner has not played a song for more than a predetermined amount of time, block 118 determines if the user selects a different channel or song title before the song has finished and if the song has played less than a second predetermined amount of time. If the user selects a different channel or song title before the song is over and the song has played less than a predetermined amount of time, then the tuner 16 stores a negative time marker in the database. As denoted by block 120, the tuner 16 can then sort a selection list based on the number of markers for a genre, title, artist, or album within the current time slot. Accordingly, the tuner anticipates the user's desired song choices and develops a selection list based on prior user listening habits. In block 122, the system logic for changing the current channel ends.

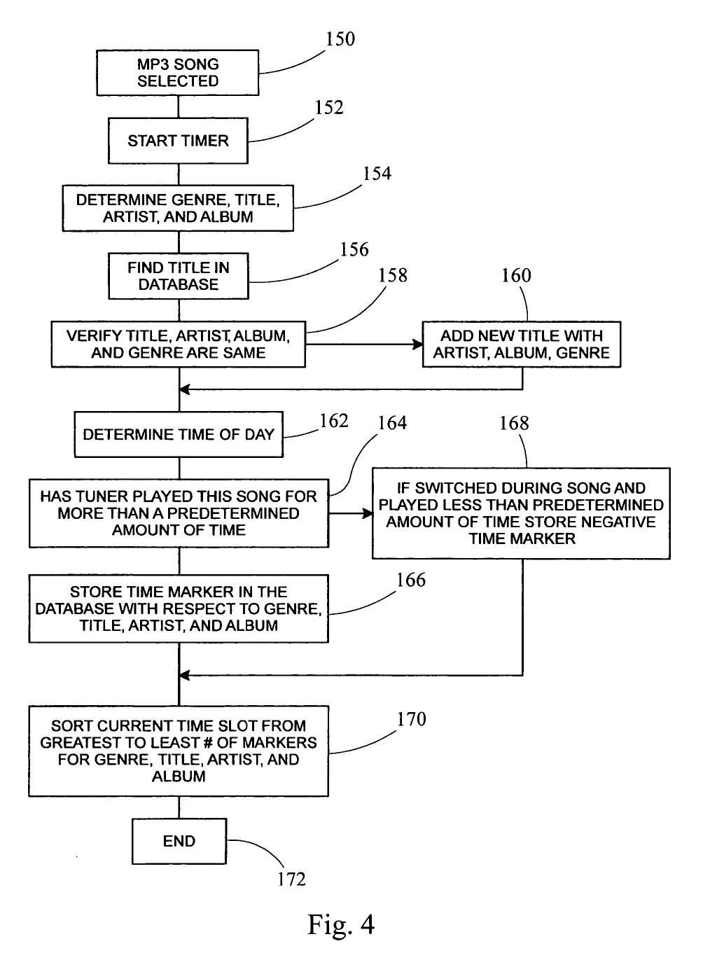

Now referring to FIG. 4, system logic is provided for selecting a song from another channel or an auxiliary device, such as an MP3 player. This is referred to as a song selection event. The logic starts in block 150 when a song is selected from an MP3 player. In block 152, a timer is started when the song begins. In block 154, the tuner determines the genre, title, artist, and album from the program information data. The tuner 16 then finds the title of the song in the database 18, as denoted by block 156. In block 158, the tuner verifies the artist, album and genre are the same for the given title. If the artist, album and genre are not the same, the logic flows to block 160 and a new title is added with the new artist, album and/or genre information. If the artist, album, and genre are the same as the database entry, the logic flows directly to block 162 and the time of day is determined. In block 164, the tuner 16 determines if the song has played for more than a predetermined amount of time. If the tuner 16 has played this song for more than a predetermined amount of time, the logic flows to block 166 and a time marker is stored in the database 18 with respect to the genre, title, artist, and album.

If the tuner 16 has not played a song for more than a predetermined amount of time, block 168 determines if the user selects a different channel or song title before the song has finished and if the song has played less than a second predetermined amount of time. If the user selects a different channel or song title before the song is over and the song has played less than the second predetermined amount of time, then the tuner 16 stores a negative time marker in the database. As denoted in block 170, the tuner 16 can then sort a selection list based on the number of markers for a genre, title, artist, or album for the current time slot. Accordingly, the tuner 16 anticipates the users desired song choices and develops a selection list based on prior user listening habits. In block 172, the system logic for selecting a song from an auxiliary device is complete.

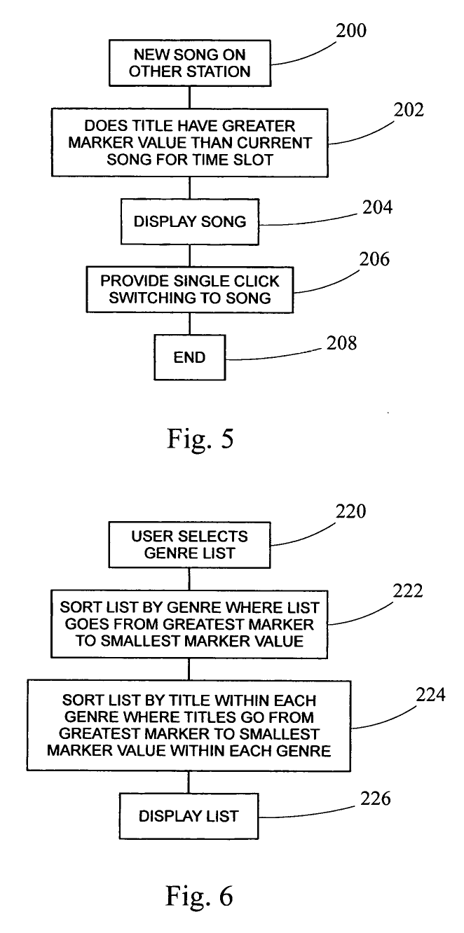

Now referring to FIG. 5, a flow chart is provided illustrating the system logic that is executed when a new song is started on a station other than the current station. The logic begins in block 200 when a new song begins playing on a station other than the current station. In block 202, the tuner 16 queries the database 18 and determines if the title of the new song has a greater marker value (i.e. number of positive time markers minus any negative time markers) than the current song for the current time slot. If the title does not have a greater marker value than the current song for the time slot, the logic follows along line 203 to the end of the process in block 208. If the song title does have a greater marker value than the current song for the current time slot, then the logic proceeds to block 204 and the song is displayed. In block 206, the user interface provides a menu or button interface allowing the user to switch the song preferably using a single click. If the user does not switch the song in block 206 by a predetermined time, the display will revert to the default display and the button or menu switching interface will be disabled and returned to its default function. The process then ends as denoted by block 208.

Now referring to FIG. 6, logic is provided for a process that is executed when the user selects a genre list. As denoted by block 220, the tuner 16 determines that the user selects a genre list. In block 222, the tuner 16 queries the database 18 for a list of known genres. The tuner 16 then sorts the list from the greatest marker value to the smallest marker value (i.e., from the most listened to genre to the least listened to genre). In block 224, the tuner 16 queries the database 18 for all the titles within a particular genre and sorts the titles from the greatest marker value to the smallest marker value for each genre. A typical list along with representative time markers is provided in Table 1 below.

TABLE 1

| | | | Marker |
|---|---|---|---|
| Genre | Title | Time Markers | Value |
| Jazz | | 3:05pm, 4:14pm, 5:30pm, | 5 |
| | | 4:30pm, 5:05pm, 5:45pm, −5:47pm | |
| | Jazz Title 1 | 3:05pm, 4:14pm, 5:30pm | 3 |
| | Jazz Title 2 | 4:30pm, 5:05pm | 2 |
| | Jazz Title 3 | 5:45pm, −5:47pm | 0 |
| Pop | | 6:30am, 6:30am, 3:17pm, | 1 |
| | | 7:30am, 8:00am, 8:15am, | |
| | | 6:45am, 7:17am, 9:15pm | |
| | Pop Title 1 | 6:30am, 3:17pm | 1 |
| | Pop Title 2 | 7:30am, 8:00am, 8:15am | 0 |
| | Pop Title 3 | 6:45am, 7:17am, 9:15pm | 0 |

For Table 1 above, the current time slot is 3:00 pm to 6:00 pm. Accordingly, only marker values within the current time slots are used in calculating the marker value. For example, the jazz genre has seven time markers between 3:00 pm and 6:00 pm. However, the −5:47 pm time marker is a negative time marker and indicates that the user changed channels during the song. Therefore the negative time marker nullifies one of the other positive time markers. Accordingly, the resulting marker value for the jazz genre is five. The pop genre has only one time marker within the time range between 3:00 pm and 6:00 pm. Therefore, the jazz genre is listed before the pop genre. Further, the titles are sorted within each genre by the number of time markers for that title within the current time slot. Accordingly, pop title 1 is listed at the top of the pop genre because it is the only pop title having a time marker within the current time slot. In block 226, the list is displayed and the user interface allows the user to select titles from the selection list. Alternatively, the user could select a genre and the tuner 16 would then play the titles in order of marker values or, alternatively, play the titles within the genre randomly.

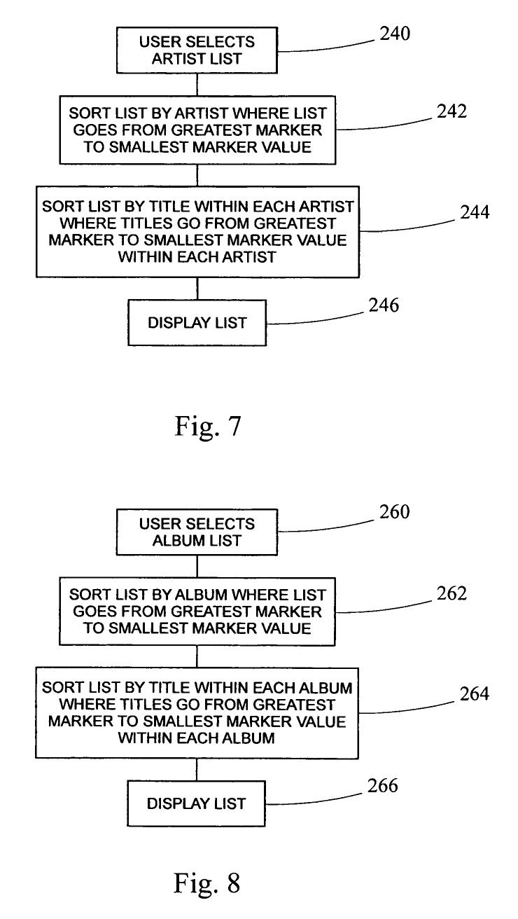

Now referring to FIG. 7, logic is provided for a process that is executed when the user selects an artist list. As denoted by block 240, the tuner 16 determines that the user selects an artist list. In block 242, the tuner 16 queries the database 18 for a list of known artists. The tuner 16 then sorts the list from the greatest marker value to the smallest marker value (i.e., from the most listened to artist to the least listened to artist). In block 244, the tuner 16 queries the database 18 for all the titles within a particular artist and sorts the titles from the greatest marker value to the smallest marker value for each artist. In block 246, the list is displayed and the user interface allows the user to select titles from the selection list. Alternatively, the user could select an artist and the tuner 16 would then play the titles in order or, play the titles within the artist randomly.

Now referring to FIG. 8, logic is provided for a process that is executed when the user selects an album list. As denoted by block 260, the tuner 16 determines that the user selects an album list. In block 262, the tuner 16 queries the database 18 for a list of known albums. The tuner 16 then sorts the list from the greatest marker value to the smallest marker value (i.e., from the most listened to album to the least listened to albums). In block 264, the tuner 16 queries the database 18 for all the titles within a particular album and sorts the titles from the greatest marker value to the smallest marker value for each album. In block 266, the list is displayed and the user interface allows the user to select titles from the selection list. Alternatively, the user could select an album and the tuner would then begin to play the titles in order or, play the titles within the album randomly.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

I claim:

1. A receiver system comprising;
a tuner configured to receive a signal including program signal data and program information data;
a database in communication with the tuner, wherein the tuner is configured to store the program information data into the database and correlate the program information data with at least one time marker indicative of user interest in the program signal data; and
wherein the tuner is configured to generate a selection list based on the time marker and the program information data.

2. The receiver system according to claim 1, wherein the tuner is configured to store a time marker of the at least one time marker based on a song selection event.

3. The receiver system according to claim 1, wherein the tuner is configured to associate a time marker of the at least one time marker with the program information data based on a new song event.

4. The receiver system according to claim 3, wherein the tuner is configured to associate a time marker of the at least one time marker with the title based on a new song event.

5. The receiver system according to claim 3, wherein the tuner is configured to associate a time marker of the at least one time marker with the genre based on a new song event.

6. The receiver system according to claim 3, wherein the tuner is configured to associate a time marker of the at least one time marker with the artist based on a new song event.

7. The receiver system according to claim 3, wherein the tuner is configured to associate a time marker of the at least one time marker with the album based on a new song event.

8. The receiver system according to claim 1, wherein the tuner is configured to generate a selection list based on the at least one time marker.

9. The receiver system according to claim 8, wherein the selection list is based on the at least one time marker and a current time slot indicative of a current time of day.

10. The receiver system according to claim 1, wherein the tuner is configured to associate a time marker of the at least one time marker with the program data based on a channel change event.

11. The receiver system according to claim 1, wherein the tuner is configured to associate a time marker of the at least one time marker with the program data based on a title selection from an auxiliary device.

12. The receiver system according to claim 1, wherein the tuner is configured to display a title of a new song based on the at least one time marker associated with the title.

13. The receiver system according to claim 12, wherein the tuner provides single click switching to the new song based on the at least one time marker associated with the title.

14. The receiver system according to claim 1, wherein the tuner is configured to generate a selection list based on a plurality of genres, and wherein each genre of a plurality of genres is sorted based on a time marker of the at least one time marker.

15. The receiver system according to claim 14, wherein the selection list is sorted by title within each genre and where each title of a plurality of titles is sorted based on a corresponding time marker of the at least one time marker.

16. The receiver system according to claim 1, wherein the tuner is configured to generate a selection list, the tuner being configured to calculate a marker value indicative of user interest in the program signal during a time slot, and wherein each artist of a plurality of artists is sorted based on a time marker of the at least one time marker.

17. The receiver system according to claim 14, wherein the selection list is sorted by title within each artist, the tuner being configured to calculate a marker value indicative of user interest in the program signal during a time slot, and where each title of a plurality of titles is sorted based on a corresponding time marker of the at least one time marker.

18. The receiver system according to claim 1, wherein the tuner is configured to generate a selection list based on a plurality of albums and wherein each album of the plurality of albums is sorted based on a time marker of the at least one time marker.

19. The receiver system according to claim 14, wherein the selection list is sorted by title within each album, the tuner being configured to calculate a marker value indicative of user interest in the program signal during a time slot, and where each title of a plurality of titles is sorted based on a corresponding time marker of the at least one time marker.
